(19) United States
(12) Patent Application Publication
(10) Pub. No.: US 2026/0251284 A1
(43) Pub. Date: Aug. 27, 2026

(54) SUNFLOWER OPTICS FOR COLOR MIXING AND BEAM SHAPING

(71) Applicant: SIGNIFY HOLDING B.V., EINDHOVEN (NL)

(72) Inventors: LUDOVICUS JOHANNES LAMBERTUS HAENEN, SINT OEDENRODE (NL); MICHAL JAN HORACZEK, BEST (NL); PETER JOHANNES MARTINUS BUKKEMS, DEURNE (NL)

(21) Appl. No.: 19/163,529

(22) PCT Filed: Mar. 7, 2024
(86) PCT No.: PCT/EP2024/055984

§ 371 Date: Sep. 9, 2025

(30) Foreign Application Priority Data
Mar. 13, 2023 (EP) 23161398.5

(51) Int. Cl. F21V 5/00; F21V 5/04

(52) U.S. Cl. CPC F21V 5/008; F21V 5/045

(57) ABSTRACT

The invention provides a light generating system comprising (i) one or more light generating devices and (ii) an optical system; wherein the one or more light generating devices are configured to generate device light; wherein the optical system is configured in a light receiving relationship with the one or more light generating devices; wherein the optical system comprises an optical arrangement; and wherein the optical arrangement comprises a first micro lens array comprising a plurality of first micro lenses configured in a first tessellated arrangement around a first central array point, wherein the first micro lenses have first radii of curvature (R_{c1}) and central first micro lens points, wherein with increasing radial distance (r1) from the first central array point, mutual first heart-to-heart distances (dₘ₁) between adjacent first micro lenses decrease, while the first radii of curvature (R_{c1}) of the first micro lenses stay substantially constant.

### FIELD OF THE INVENTION

The invention relates to a light generating system. The invention further relates to a lighting device comprising said light generating system.

### BACKGROUND OF THE INVENTION

Color mixing and beam shaping optics are known in the art, for instance US2019024872A1 describes an optical system configured such that the relation between the incident angle and the emergence distance of the emergent optical beam relative to the main optical axis O-O is proportionally decreasing so as to mix the colors in a homogeneous manner, and an emergent surface textured so as to make uniform the homogenization of the additive synthesis. The image of the light source is uniformly homogeneous and decorrelated from the shape of same.

WO2020148242A1 discloses an optical system comprising non-imaging optics for use with a light source in the form of an LED array.

US20210278646A1 discloses an integrating lenslet arrangement comprising a plurality of transmissive planar facets covering pockets in between the lenslets.

### SUMMARY OF THE INVENTION

There is a growing desire for optical devices having improved efficiency in terms of energy consumption, color mixing and illumination uniformity. Current illumination applications often make use of known collimators for beam shaping. However, many collimators tend to reproduce at least part of the spatial structure of the light source. Non-uniform light sources such as e.g. light emitting diode (LED) arrays and LEDs of different colors may therefore cause visible artefacts in the resulting light beam after collimation with a collimator. Other known beam modification optics capable of modifying beam width, beam shape and color (temperature) include optical plates, such as lens arrays and louvres. Such optical plates can be attached to for example LED spots by e.g. a magnet or a mechanical snap lock. However, a drawback of using such beam shape modifiers based on lenses or louvres is that such optics require a lot of space (height) in the product. In for example lamp retrofit applications such space requirements are not always allowable.

Hence, it is an aspect of the invention to provide an alternative light generating system, which preferably further at least partly obviates one or more of above-described drawbacks. The present invention may have as object to overcome or ameliorate at least one of the disadvantages of the prior art, or to provide a useful alternative.

According to a first aspect, the invention provides a light generating system (“system”) comprising one or more light generating devices and an optical system. The light generating devices may especially be configured to generate device light. In embodiments, the light generating devices may be configured to generate visible device light, i.e., device light having a wavelength in the visible wavelength range. The optical system may be configured in a light receiving relationship with the one or more light generating devices.

Especially, in embodiments, the optical system may comprise an optical arrangement (configured in a light receiving relationship with the one or more light generating devices). In embodiments, the optical arrangement may comprise a first micro lens array. Especially, the first micro lens array may comprise a plurality of first micro lenses. More especially, the plurality of first micro lenses (in the first micro lens array) may be configured in a first tessellated arrangement around a first central array point. The first micro lenses may have first radii of curvature (R_{c1}) and central first micro lens points. The first radii of curvature (Rc1) may have a number averaged average value (Rc1a). Especially, the first radii of curvature (Rc1) for at least 95% of the first micro lenses may be selected from the range of 0.95*R_{c1a}-1.05*R_{c1a}. In specific embodiments, 0.98*R_{c1a}-1.02*R_{c1a}. Hence, in embodiments with increasing radial distance (r1) from the first central array point, the first heart-to-heart distances (dm1) between adjacent first micro lenses may decrease, while the first radii of curvature (Rc1) for at least 95% of the first micro lenses (stay essentially constant and) are selected from the range of 0.95*R_{c1a}-1.05*R_{c1a}. In embodiments, with increasing radial distance (r1) from the first central array point, the first radii of curvature (R_{c1}) may stay constant, i.e. all radii of curvature may be or are (essentially) the same. Especially, the first radii of curvature (R_{c1}) may stay constant with increasing radial distance (r1) from the first central array point, while mutual first heart-to-heart distances (dₘ₁) between adjacent first micro lenses may decrease. Hence, in specific embodiments, the invention provides a light generating system comprising (i) one or more light generating devices and (ii) an optical system; wherein the one or more light generating devices are configured to generate device light; wherein the optical system is configured in a light receiving relationship with the one or more light generating devices; wherein the optical system comprises an optical arrangement; and wherein the optical arrangement comprises a first micro lens array comprising a plurality of first micro lenses configured in a first tessellated arrangement around a first central array point, wherein the first micro lenses have first radii of curvature (R_{c1}) and central first micro lens points, wherein with increasing radial distance (r1) from the first central array point, mutual first heart-to-heart distances (dₘ₁) between adjacent first micro lenses decrease, while the first radii of curvature (R_{c1}) of the first micro lenses stay constant.

With such light generating devices and such optics a light generating system can be provided with the desired beam properties (beam shaping and color mixing), such as suitable for a specific room or space. Hence, with the beam modifying and color mixing optics the properties of the device light beam of the light generating devices can be modified. Further, hardly any depth is needed for the light generating system as described herein, as the optics arrangement can be very thin, such as in the range up to a few millimeters. Yet further, with the present invention good glare control of the device light may be provided. Herein, amongst others a light generating system comprising beam modifying optics is proposed. The invention may be of special relevance for most directional lighting devices, such as for example spot lamps, spot luminaires, and wall washing fixtures.

Hence, the invention may provide a light generating system. The light generating system may be configured to generate system light, especially a beam of system light. Therefore, in embodiments, the light generating system may comprise one or more light generating devices and an optical system. Especially, in embodiments, the light generating system may comprise at least two light generating devices, such as at least three light generating devices.

The one or more light generating devices may be configured to generate device light. In embodiments, the light generating devices may be configured to generate device light having a wavelength in the visible wavelength range, i.e. 380-780 nm. However, in embodiments, the light generating devices may also be configured to generate device light having a wavelength in a different wavelength range, such as the UV wavelength range.

Further, in some embodiments, the light generating devices may provide device light having a wavelength such that the device light may be white light. Hence, in such embodiments, the system light may especially be (non-monochromatic, such as) white light, see also further below. Therefore, in embodiments, the one or more light generating devices may each comprise a light source. In embodiments, the one or more light generating devices may each comprise the same type of light source. In other embodiments, the light generating devices may comprise different types of light sources. Light generating devices and types of light sources will be further elucidated below.

In embodiments, the one or more light generating devices may especially be configured to provide device light to the optical system. In particular, the optical system may be configured in a light receiving relationship with the one or more light generating devices. The one or more light generating devices may, in embodiments, especially have a (device) optical axis (O). In particular, the (device) optical axis (O) may be the optical axis of device light propagating from the light generating device (to the optical system).

The optical system may, in embodiments, comprise an optical arrangement.

The optical arrangement may especially be configured downstream relative to the one or more light generating devices.

The terms “upstream” and “downstream” relate to an arrangement of items or features relative to the propagation of the light from a light generating means (here especially the one or more light generating devices), wherein relative to a first position within a beam of light from the light generating means, a second position in the beam of light closer to the light generating means is “upstream”, and a third position within the beam of light further away from the light generating means is “downstream”.

Herein, the optical arrangement may comprise one or more optical elements. Especially, the optical arrangement may comprise a first micro lens array. The first micro lens array may comprise a plurality of first micro lenses. Especially, in embodiments, the first micro lens array may comprise at least 10 first micro lenses, such as at least 15 first micro lenses, like at least 25 first micro lenses, especially at least 50 first micro lenses. In embodiments, the first micro lens array may comprise at most 200 first micro lenses, such as at most 100 first micro lenses, like at most 50 first micro lenses. The first micro lenses may especially be lenses having a relatively small diameter, such as a diameter selected from the range of 5 μm-20 mm, like from the range of 10 μm-10 mm, especially from the range of 100 μm-1 mm. In embodiments, the first micro lenses may have a diameter selected from the range of 1-5 mm.

The plurality of first micro lenses may, in embodiments, be configured in a first tessellated arrangement around a first central array point. In embodiments, the first micro lens array may comprise an array of first micro lenses configured around a center point, especially, configured around the first central array point. Hence, the first central array point may form the center of the tessellated arrangement. In such a way, the plurality of first micro lenses may be configured to focus the device light provided by the one or more light generating devices. The term “tessellated” and similar terms thereto may be defined as an arrangement of (substantially equal) shapes, such as substantially equal micro lenses, fitted together in a repeated pattern. Using micro lenses of substantially equal shape may facilitate ease in manufacturing. However, using micro lenses of differing shape is herein not excluded.

Further, in embodiments, the first micro lenses may have first radii of curvature (R_{c1}). Herein a radius of curvature especially refers to a radius of a circle which approximates the shape of the curved element, i.e. the lens. In embodiments, the radii of curvature (R_{c1}) of the first micro lenses may be individually selected from the range of 0.05-20 mm, such as from the range of 0.1-5 mm, like from the range of 0.2-1 mm. Especially, therein the curvature and first radii refer to a curvature in a plane parallel to an optical axis of the micro lens array and/or a plane perpendicular to a (curved) plane through the micro lens array. As will be explained below, the first radii may essentially be the same for all first micro lenses.

Yet further, in embodiments, each first micro lenses may each have a central first micro lens point. The distance between the central first micro lens point of two adjacent micro lenses may be defined as a mutual first heart-to-heart distance (dₘ₁). In embodiments, the mutual first heart-to-heart distances (dₘ₁) between the plurality of first micro lenses may be selected from the range of 100 μm-10 mm, such as from the range of 200 μm-5 mm, like from the range of 0.5-1 mm. As the plurality of first micro lenses may be configured around a first central array point in a tessellated arrangement, each first micro lens may have a (different) radial distance (r1) from the first central array point. The radial distances for the plurality of first micro lenses may, in embodiments, be selected from the range of 1-500 mm, like from the range of 1-100 mm, such as from the range of 5-50 mm. As will be explained below, in embodiments, the first heart-to-heart distance (dₘ₁) may vary over the micro lens array. In other embodiments, the first heart-to-heart distance (dₘ₁) may stay the same over the micro lens array.

Herein, with increasing radial distances (r1), in embodiments, the mutual first heart-to-heart distances (dₘ₁) between adjacent first micro lenses may decrease. More especially, as the radial distances (r1) may increase and the mutual first heart-to-heart distances (dₘ₁) between adjacent first micro lenses may decrease, the first radii of curvature (R_{c1}) may stay constant, i.e., may not vary. Hence, in embodiments, micro lenses closer to the first central array point (thus having a smaller radial distance (r1)) may have approximately the same (or a substantially equal) radius of curvature (R_{c1}) as micro lenses further away from the first central array point (thus having a larger radial distance (r1)). However, in such embodiments, the micro lenses closer to the first central array point (thus having a smaller radial distance (r1)) may have a larger mutual first heart-to-heart distance (dₘ₁) than the micro lenses further away from the first central array point (thus having a larger radial distance (r1)). In other words, when moving away from the first central array point, the micro lenses may be configured closer together. Hence, in embodiments, the first tessellation arrangement may especially comprise a progressive tessellation arrangement. A progressive tessellation may, herein, thus refer to an arrangement of shapes, i.e., micro lenses, closely fitted together in a repeated pattern, with increasing density as the pattern progresses.

Light incident on the first micro lenses closer to the first central array point may require more mixing than light incident on the first micro lenses configured further away from the first central array point. This may especially be the case as the beam spread provided by the first micro lenses at a larger radial distance (r1) may be smaller. Therefore, the progressive sunflower arrangement may be beneficial, as a relatively low density of first micro lenses near the first central array point may provide a wide beam spread, i.e., may provide more color mixing, compared to a higher density of first micro lenses located further away from the first central array point.

The decrease of the heart-to-heart distances (dₘ₁) with increasing radial distances (r1) may be gradually or may be step-wise. In both embodiments, there may be at least three different the heart-to-heart distances (dₘ₁), more especially at least four. However, larger values may also be possible, especially when the decrease is gradual.

The phrase “stay constant with increasing radial distance (r1)”, and similar phrases, refer to staying essentially constant or substantially constant. Small deviations may be possible, but essentially the first radii of curvature may stay constant. As stated, the first radii of curvature (R_{c1}) may have a number averaged average value (R_{c1a}). Especially, the first radii of curvature (R_{c1}) for at least 95% of the first micro lenses may be selected from the range of 0.95*R_{c1a}-1.05*R_{c1a}. In specific embodiments, 0.98*R_{c1a}-1.02*R_{c1a}. Hence, in embodiments the first heart-to-heart distances (dₘ₁) between adjacent first micro lenses may decrease, while the first radii of curvature (R_{c1}) for at least 95% of the first micro lenses (stay essentially constant and) are selected from the range of 0.95*R_{c1a}-1.05*R_{c1a}.

More especially, the mutual first heart-to-heart distances (dₘ₁) may have (i) a first maximum value (dₘₓ₁) closer to the first central array point, and a first minimum value (dₘₘ₁) at a periphery of the first micro lens array. In embodiments, 0.01≤dₘₘ₁/dₘₓ₁≤0.95, such as 0.1≤dₘₘ₁/dₘₓ₁≤0.9. Hence, in embodiments two or more micro lenses closest at the first central array point, especially more than two or more micro lenses, may have first heart-to-heart distances (dₘ₁) having the first maximum value (dₘₓ₁). Further, in embodiments two or more micro lenses configured most peripheral from the first central array point, especially more than two or more micro lenses, may have first heart-to-heart distances (dₘ₁) having the first minimum value (dₘₘ₁). Hence, in embodiments a ratio of the smallest heart-to-heart distances (dₘ₁) to the largest heart-to-heart distances (dₘ₁) may be selected from the range of 0.01-0.95, such as selected from the range of 0.01-0.9, like selected from the range of 0.1-0.9. In embodiments, the first tessellated arrangement may especially comprise a sunflower arrangement. More especially, the first tessellated arrangement may, in embodiments, comprise a progressive sunflower arrangement.

Hence, in specific embodiments the first radii of curvature (R_{c1}) have a number averaged average value (R_{c1a}), wherein the first radii of curvature (R_{c1}) for at least 95% of the first micro lenses are selected from the range of 0.95*R_{c1a}-1.05*R_{c1a}; and wherein the mutual first heart-to-heart distances (dₘ₁) have a first maximum value (dₘₓ₁) closer to the first central array point, and a first minimum value (dₘₘ₁) at a periphery of the first micro lens array, wherein 0.1≤dₘₘ₁/dₘₓ₁≤0.9. More especially, in embodiments the first tessellated arrangement comprises a sunflower arrangement, yet more especially a progressive sunflower arrangement (i.e. with increasing radial distances (r1), in embodiments, the mutual first heart-to-heart distances (dₘ₁) between adjacent first micro lenses may decrease).

Such embodiments may be beneficial as a sunflower arrangement may provide improved color mixing of light provided to the micro lens array. Further, the micro lens array may display efficient beam shaping when using a sunflower arrangement. Hence, the invention may provide an improved light generating system using sunflower optics for color mixing and beam shaping.

In embodiments, the plurality of first micro lenses may thus be configured in a sunflower arrangement. Such a sunflower arrangement may be represented in polar coordinates given by the equations: r1=c*SQRT[n] and θ=n*±(360°/(1.618034±q)), wherein r1 is the radial distance from the first central array point, c is a constant scaling factor, n is the index number of the micro lens, q is selected from 0, 1, 2, 3, . . . , 50, and θ is the step angle from n to n+1. In embodiments, q may (also) be a thousandths decimal point variation of 1, 2, 3, . . . , 50, e.g., 1.001, or 2.005. Increasing c, while keeping the number of micro lenses constant may result in an increased radial distance (r1), with increasing mutual first heart-to-heart distances (dₘ₁), whereas decreasing c, while keeping the number of micro lenses constant may result in a decreased radial distance (r1), with decreasing mutual first heart-to-heart distances (dₘ₁). Additionally or alternatively, in embodiments, the mutual first heart-to-heart distances (dₘ₁) may differ, such that smaller mutual first heart-to-heart distances (dₘ₁) may be found for first micro lenses located further away from the first central array point relative to the mutual first heart-to-heart distances (dₘ₁) of the first micro lenses located closer to the first central array point. In such embodiments, the plurality of first micro lenses is especially configured in a progressive sunflower arrangement. Such a progressive sunflower arrangement may be represented in polar coordinates given by the equations as described above for the sunflower arrangement, but wherein r1=c*x*SQRT[n] and θ=n*±(360/(1.618034±q)). Hence, there is no longer constant scaling as x is a variable that may be changed (e.g. decreased) incrementally as the radial distance (r1) increases. By decreasing x, the first micro lenses in the first tessellated arrangement become more densely populated with increasing r1, whereas by increasing x, the first micro lenses in the first tessellated arrangement become more spaciously populated with increasing r1. A first tessellated arrangement that is more densely populated with increasing r1 may be beneficial in embodiments where the first micro lens array receives a wide beam spread. In embodiments, for a relatively wide beam spread, the variable x may be at most 0.9, such as at most 1.0, like at most 1.1. Further, a first tessellated arrangement that is more spaciously populated with increasing r1 may be beneficial in embodiments where the first micro lens array receives a narrow beam spread, i.e., a more focused beam for example as a result of the collimator element. In embodiments, for a relatively narrow beam spread, the variable x may be less than 1.0, such as less than 0.8, like less than 0.5.

As mentioned above, in embodiments, the mutual first heart-to-heart distances (dₘ₁) of the plurality of first micro lenses may differ when configured in a progressive (sunflower) arrangement. Especially, in embodiments, the mutual first heart-to-heart distances (dₘ₁) may have a first maximum value (dₘₓ₁) closer to the first central array point, and a first minimum value (dₘₘ₁) at a periphery of the first micro lens array. In embodiments, the first maximum value (dₘₓ₁) may be at least 1 mm, such as at least 5 mm, like at least 10 mm. Further, in embodiments, the first minimum value (dₘₘ₁) may be at most 1 mm, such as at most 500 μm, like at most 100 μm. Especially, in embodiments, the first minimum value (dₘₘ₁) and the first maximum value (dₘₓ₁) may be selected such, that 0.1≤dₘₘ₁/dₘₓ₁≤0.9, like 0.25≤dₘₘ₁/dₘₓ₁≤0.75. For example, in embodiments, the first minimum value (dₘₘ₁) may be half the first maximum value (dₘₓ₁), e.g., dₘₘ₁=500 μm and dₘₓ₁=1 mm. Further, in embodiments, the mutual first heart-to-heart distances (dₘ₁) may especially have the first maximum value (dₘₓ₁) at a position where maximal mixing of light may be required. In most embodiments, this may be at a periphery of the first micro lens array. However, in some other embodiments, this may not necessarily be at a periphery of the first micro lens array.

Hence, in embodiments a ratio of the smallest heart-to-heart distances (dₘ₁) to the largest heart-to-heart distances (dₘ₁) may be selected from the range of at maximum 0.75, such as at maximum 0.5, like selected from the range of 0.01-0.5, like selected from the range of 0.1-0.5.

Further, in embodiments, such as with the sunflower arrangement, the first radii of curvature (R_{c1}) of the plurality of first micro lenses may be essentially equal.

Especially, in embodiments, the first radii of curvature (R_{c1}) may have a number averaged average value (R_{c1a}). The number averaged average value (R_{c1a}) may, in embodiments, be a value selected from the range of 0.1-15 mm, such as from the range of 0.5-10 mm, like from the range of 0.5-5 mm. Further, in embodiments, at least 95% of the first micro lenses, such as at least 98% of the first micro lenses, like at least 99% of the first micro lenses may have a first radius of curvature (R_{c1}) selected from the range of 0.95*R_{c1a}-1.05*R_{c1a}, like from the range of 0.98*R_{c1a}-1.02*R_{c1a}. In specific embodiments, all of the radii of curvature (R_{c1}) of the plurality of first micro lenses may be identical, i.e., for 100% of the plurality of first micro lenses may apply: R_{c1}-R_{c1a}.

The light generating system may further, in embodiments, comprise additional optical elements. Especially, in embodiments, the light generating system may comprise a collimator element. More especially, the collimator element may be configured downstream of the one or more light generating devices and upstream of the first micro lens array. The addition of a collimator element may be beneficial as it may enable consistent provision of device light to the surface of the first micro lens array. In such a way, efficient controllability of color mixing and beam shaping may be achieved.

Hence, in embodiments, a collimator element may be configured between the one or more light generating devices and the first micro lens array. The collimator element may thus be configured in a light receiving relationship with the one or more light generating devices. In other words, the collimator element may be configured downstream of the one or more light generating devices and upstream of the first micro lens array. Further, in embodiments, the collimator element may be configured to collimator the device light, such that a collimated beam of device light may be provided to the first micro lens array. The first micro lens array may thus be configured in a light receiving relationship with the collimator element.

In embodiments, the collimator element may comprise a lens. The collimator element may (even) comprise one or more lenses. In other embodiments, the collimator element may comprise a curved mirror. In yet other embodiments, the collimator elements may comprise a total internal reflection collimator (TIR). Other types of collimator elements not mentioned are herein not excluded.

In specific embodiments, the collimator element may comprise a Fresnel-like lens element. A Fresnel lens element is made by dividing a conventional lens into a set of concentric sections, such as concentric annular rings, where for each section the overall thickness of the lens is decreased while remaining the same curvature. Hence, the Fresnel lens element may provide a functionality similar to a conventional lens but with a reduced overall thickness of the lens. In embodiments, the collimator element may essentially be a Fresnel lens element. However, in other embodiments, the collimator may be a Fresnel-like lens element, i.e., the collimator element is not truly a Fresnel lens but has close similarity to one. For example, in embodiments, the collimator element may only partially comprise a Fresnel lens functionality.

The collimator element, especially the Fresnel-like lens element may, in embodiments, especially be configured to collimate the device light received by the collimator element through total internal reflection (TIR). Hence, collimated device light may arrive at the first lens array.

In embodiments, the optical arrangement may thus comprise the collimator element and the first micro lens array. Especially, in embodiments, the collimator element may comprise a first lens part and a second lens part. More especially, the second lens part may, in embodiments, comprise a lower second lens part and an upper second lens part. The upper second lens part may, in embodiments, be configured downstream of the first lens part. Furthermore, the first micro lens array may, in such embodiments, be configured downstream of the upper second lens part. In embodiments, the first lens part may be configured to collimate device light received by the first lens part through total internal reflection (TIR). Further, in embodiments, the second lens part may be configured to collimate device light received by the second lens element through refraction. Yet further, in embodiments, the first micro lens array may be configured to beam shape and mix device light received by the first micro lens array. Hence, in specific embodiments, the optical arrangement may comprise (a) the collimator element, and (b) the first micro lens array, wherein the collimator element may comprise (i) a first lens part, configured to collimate the device light received by the first lens part through total internal reflection, and (ii) and a second lens part, configured to collimate the device light received by the second lens part through refraction; and wherein the first micro lens array may be configured downstream of the first lens part and the second lens part, and may be configured to beam shape and mix device light received by the first micro lens array.

For example, in embodiments, the collimator element may comprise a Fresnel lens. In such embodiments, the Fresnel lens may be configured in a light receiving relationship with the light generating devices, such that essentially all device light is received by the Fresnel lens. The Fresnel lens may be configured to collimate essentially all device light (through TIR) to provide collimated device light to the first micro lens array.

In another example, the collimator element may comprise a Fresnel-like lens element, such that the Fresnel-like lens element is configured to receive part of the device light generated by the light generating devices. Especially, in such embodiments, the collimator element may comprise a first lens part and a second lens part. In embodiments, the first lens part may comprise the Fresnel-like lens element. Especially, the first lens part may be configured in a light receiving relationship with the light generating devices, such that the first lens part may be configured to receive part of the device light generated by the light generating devices. Subsequently, the first lens part (e.g. the Fresnel-like lens element) may be configured to collimate the part of device light received by the first lens part (e.g. the Fresnel-like lens element) through total internal reflection (TIR). Further, in embodiments, the second lens part may comprise a lower second lens part and an upper second lens part.

Especially, in embodiments, the lower second lens part may be configured such that the first lens part may essentially fully surround the lower second lens part in a plane perpendicular to the optical axis (O). However, in other embodiments, the first lens part and the lower second lens part may be configured in a different way relative to each other (, e.g. the lower second lens part may be configured downstream of the first lens part). Further, in embodiments, the upper second lens part may be configured downstream of the first lens part (and/or the lower second lens part). The lower second lens part and the upper second lens part may together function as a (convex) refractive lens. In such embodiments, device light incident on the lower second lens part may thus be collimated by the collaborative refractive function of the lower second lens part and the upper second lens part.

In embodiments, the first micro lens array may be configured downstream of the upper second lens part. Especially, in embodiments, the first micro lens array may be configured on the upper second lens part, such that the first micro lens array may be curved over the upper second lens part. Hence, in such embodiments, a curved light exit surface may be provided. In embodiments, the first lens part (i.e., the Fresnel-like lens element) and the second lens part may together provide collimated device light to the first micro lens array. The first micro lens array may thus receive device light collimated by the (first lens part and second lens part of the) collimator element. Subsequently, the first micro lens array may be configured to beam shape and mix the device light received by the first micro lens array. Hence, in embodiments, the first micro lens array may provide a (beam shaped) beam of device light. Especially, in embodiments, the (beam shaped) beam of device light may have a beam width α. The beam width α may, in embodiments, be selected from the range of 25-55°. Especially, in embodiments, the beam width α may be at most 50°, such as at most 45°.

In embodiments, the light generating system may comprise a first optical arrangement body. Especially, the optical arrangement body may comprise at least the collimator element, and the first micro lens array. It is herein not excluded that the first optical arrangement body may comprise additional optical elements, such as a lens, a reflector, or a polarizer. Further, in embodiments, the first optical arrangement body may be an integrated body. Hence, in specific embodiments, the light generating system may comprise a first optical arrangement body, wherein the first optical arrangement body comprises the collimator element, and the first micro lens array.

Using an integrated body for the first optical arrangement may provide the benefit of fast integration during manufacturing of the light generating system.

In embodiments, the first optical arrangement body may for example be manufactured through vacuum-casting, i.e., the first optical arrangement body may be a vacuum-casted body. In other embodiments the first optical arrangement body may be manufactured through injection molding, i.e., the first optical arrangement body may be an injection molded body. In yet other embodiments, first optical arrangement body may be manufactured through direct milling, i.e., the first optical arrangement body may be a milled body. In yet other embodiments, the first optical arrangement body may be manufactured through printing, i.e., the first optical arrangement body may be a printed body.

For instance, in embodiments when milling the mold one can use the same tool with certain curvature for all the micro lenses. Only distance towards micro lenses may be changed. The closer the micro-lenses to each other the less spreading of the light may be.

Further, in embodiments, the first optical arrangement body may have a light exit surface. The first micro lens array may, in embodiments, be configured on the light exit surface. In some embodiments, especially, the light exit surface may be a curved light exit surface. Therefore, the first micro lens array may (also), in embodiments, be configured on the curved light exit surface.

In embodiments, the light generating system may (also) comprise a Koehler integrator element (i.e., additionally or alternatively to a Fresnel-like lens element).

Especially, the Koehler integrator element may be configured downstream of the one or more light generating devices. In embodiments, the Koehler integrator element may comprise (a) a second micro lens array comprising a plurality of second micro lenses configured in a second tessellated arrangement, and (b) the (afore-mentioned) first micro lens array. Especially, in such embodiments, the first micro lenses and the second micro lenses may be aligned.

Furthermore, in embodiments, the first micro lenses may be configured downstream of the second micro lenses. Hence, in specific embodiments, the light generating system may comprise a Koehler integrator element, configured downstream of the one or more light generating devices, wherein the Koehler integrator element comprises (a) a second micro lens array comprising a plurality of second micro lenses configured in a second tessellated arrangement, and (b) the first micro lens array, wherein the first micro lenses and the second micro lenses are aligned, and wherein the first micro lenses are configured downstream of the second micro lenses. Such embodiments may especially be beneficial for improving the color mixing and glare control of the light generating system. Improvement is achieved as in Koehler optics, the light output produced is less influenced by variations in the light source, such as by the use of different types of light generating devices and variations in their placement relative to each other.

In general, Koehler optics may, in embodiments, comprise two optical elements, such as two lenses or two micro lens arrays. The two optical elements may especially be configured in a proximity relative to each other, such that the two optical elements are located in each other's focus point.

Herein, in embodiments, the Koehler integrator element may be configured downstream of the one or more light generating devices. Hence, the Koehler integrator element may be configured in a light receiving relationship with the one or more light generating devices. In such a way, the Koehler integrator element may be configured to color mix and beam shape the device light received by the Koehler integrator element.

The Koehler integrator element may, in embodiments, especially comprise the first micro lens array (as described above) and a second micro lens array. The second micro lens array may comprise a plurality of second micro lenses. Especially, in embodiments, the second micro lens array may comprise at least 10 second micro lenses, such as at least 15 second micro lenses, like at least 25 second micro lenses, especially at least 50 second micro lenses. In embodiments, the second micro lens array may comprise at most 200 second micro lenses, such as at most 100 second micro lenses, like at most 50 second micro lenses. The second micro lenses may especially be lenses having a relatively small diameter, such as a diameter selected from the range of 5 μm-1 mm, like from the range of 10 μm-1 mm, especially from the range of 10 μm-0.1 mm.

Further, the first micro lens array may have a first focus point. Similarly, the second micro lens array may have a second focus point. Especially, in embodiments, the first micro lenses and the second micro lenses may be aligned. Hence, the optical axes of the micro lenses of the two arrays may essentially coincide. Especially, in embodiments, the first micro lens array and the second micro lens array may be configured relative to each other, such that the first micro lens array may be positioned essentially in the second focus point, and the second micro lens array may be positioned essentially in the first focus point.

Especially, the first micro lenses may be configured aligned with and downstream of the second micro lenses.

Herein, the first micro lens array may be configured downstream of the second micro lens array. Further, in embodiments the Koehler optics may comprise a single body comprising the first micro lens array and the second micro lens array.

Yet further, in embodiments, the plurality of second micro lenses may, in embodiments, be configured in a second tessellated arrangement around a second central array point. In such a way, the plurality of second micro lenses may be configured to focus the device light provided by the one or more light generating devices. In embodiments, the second tessellated arrangement may essentially be equal to the first tessellated arrangement. However, in other embodiments, the second tessellated arrangement may be different from the first tessellated arrangement. Hence, in embodiments, the first micro lens array and the second micro lens array may be essentially equal. Therefore, in embodiments the conditions in relation to first micro lens array may apply as well to the second micro lens array. For instance, in embodiments i.e. with increasing radial distances, the mutual (second) heart-to-heart distances between adjacent second micro lenses may decrease (in the same way as for the first micro lens array).

As mentioned above, in embodiments, the first tessellated arrangement may comprise a (progressive) sunflower arrangement. Similarly, in embodiments, the second tessellated arrangement may (also) comprise a sunflower arrangement, such as a progressive sunflower arrangement. Hence, in embodiments, the first tessellated arrangement and the second tessellated arrangement may (both) comprise sunflower arrangements. Especially, in embodiments, the first tessellated arrangement and the second tessellated arrangement may comprise essentially the same sunflower arrangement. However, in other embodiments, the first tessellated arrangement and the second tessellated arrangement may comprise (slightly) different sunflower arrangements.

Further, in embodiments where the light generating system comprises the Koehler integrator element, the light generating system may (also) comprise the collimator element as defined above. Especially, in such embodiments, the Koehler integrator element may be configured downstream of the collimator element (such as in embodiments a Fresnel lens). Hence, in specific embodiments, the light generating system may comprise the collimator element and the Koehler integrator element, wherein the Koehler integrator element may be configured downstream of the collimator element. Especially, in such embodiments, however, the Koehler integrator element and the collimator element do not form an integrated (single) body (see also below).

The addition of a collimator element may be beneficial as it may enable consistent provision of device light to the surface of the second micro lens array. In such a way, efficient controllability of color mixing and beam shaping may be achieved (see also above).

Hence, in embodiments, the collimator element may be configured between the one or more light generating devices and the second micro lens array. The collimator element may thus be configured in a light receiving relationship with the one or more light generating devices. Further, in embodiments, the collimator element may be configured to collimate the device light, such that a collimated beam of device light may be provided to the second micro lens array. The second micro lens array may thus be configured in a light receiving relationship with the collimator element. Additionally, in embodiments, the first micro lens array may be configured in a light receiving arrangement with the second micro lens array. Hence, in embodiments, the second micro lens array may be configured to focus the collimated beam of device light, such that a focused beam of device light may be provided to the first micro lens array.

The Koehler integrator element and the collimator element may be two separate elements. In embodiments, the Koehler integrator may for example be manufactured through vacuum-casting, injection molding, or direct milling. Likewise, this may apply to the collimator element.

Referring back to embodiments where the light generating system comprises the Koehler integrator elements, the first micro lens array and the second micro lens array may especially be mirror images of each other (relative to a plane configured in between).

Especially, in embodiments, the amount of second micro lenses (in the second micro lens array) may essentially be equal to the amount of first micro lenses (in the first micro lens array). More especially, essentially each first micro lens may be aligned with a respective, associated second micro lens. Further, in embodiments, the second micro lenses may essentially have a diameter equal to the first micro lenses. Yet further, in embodiments, the first tessellated arrangement and the second tessellated arrangement may especially be the same, but mirrored, arrangements, such that the first and second micro lens array may be configured in each other's focus points. Hence, in such embodiments, the first micro lens array and the second micro lens array may thus be the same, but mirrored, micro lens array. However, in other embodiments, the first micro lens array and the second micro lens array may be different.

In embodiments, the first micro lens array may comprise at least 15 first micro lenses, especially at least 25 first micro lenses, such as at least 50 first micro lenses, especially at least 100 first micro lenses. Further, in embodiments, at most 10%, such as selected from the range of 0.0001-5%, especially at most 2%, more especially 0.001-2% of the first micro lenses may have mutual first heart-to-heart distances (dₘ₁) selected from the range of 1.0-20 mm, such as selected from the range of 1.0-10 mm. Especially, in embodiments, the mutual first heart-to-heart distances (dₘ₁) may be selected from the range of 0.5-15 mm, such as from the range of 1.5-7.5 mm. Hence, in specific embodiments, the first micro lens array comprises at least 25 micro lenses; wherein selected from the range of 0.0001-5% of the first micro lenses have mutual first heart-to-heart distances (dₘ₁) selected from the range of 1.0-20 mm.

Similarly, in embodiments where the light generating system comprises the second micro lens array, the second micro lens array may comprise at least 15 second micro lenses, especially at least 25 second micro lenses, such as at least 50 second micro lenses, especially at least 100 second micro lenses. Further, in embodiments, at most 10%, such as selected from the range of 0.0001-5%, especially at most 2%, more especially 0.001-2% of the second micro lenses may have mutual second heart-to-heart distances (dₘ₂) selected from the range of 1.0-20 mm, such as selected from the range of 1.0-10 mm. Especially, in embodiments, the mutual second heart-to-heart distances (dₘ₂) may be selected from the range of 0.5-15 mm, such as from the range of 1.5-7.5 mm. Hence, in specific embodiments, the second micro lens array comprises at least 25 micro lenses; wherein selected from the range of 0.0001-5% of the second micro lenses have mutual second heart-to-heart distances (dₘ₂) selected from the range of 1.0-20 mm.

Yet in other embodiments, at least 80%, such as at least 90%, especially at least 95%, more especially at least 98% of the first micro lenses may have mutual first heart-to-heart distances (dₘ₁) selected from the range of smaller than 1.0 mm. Especially, in embodiments, dₘᵢ≤0.95 mm, such as dₘᵢ≤0.75 mm, like dₘ₁≤0.5 mm. Hence, in specific embodiments, the first micro lens array may comprise at least 25 micro lenses, wherein at least 95% of the first micro lenses may have mutual first heart-to-heart distances (dₘ₁) selected from the range of smaller than 1.0 mm, such as smaller than 0.5 mm.

Similarly, in embodiments where the light generating system comprises the second micro lens array, at least 80%, such as at least 90%, especially at least 95%, more especially at least 98% of the second micro lenses may have mutual second heart-to-heart distances (dₘ₂) selected from the range of smaller than 1.0 mm. Especially, in embodiments, dₘ₂≤0.95 mm, such as dₘ₂≤0.75 mm, like dₘ₂≤0.5 mm. Hence, in specific embodiments, at least 95% of the second micro lenses have mutual second heart-to-heart distances (dₘ₂) selected from the range of smaller than 1.0 mm, such as smaller than 0.5 mm.

As mentioned above, the light generating system may comprise different types of light sources, especially different types of light generating devices. The present invention may especially accommodate the use of different types of light generating devices, as the system described herein provides an improved color mixing and beam shaping functionality. Hence, the impact of using separate and different light generating devices may be negated by the optical elements as described herein. Therefore, in embodiments, the one or more light generating devices may comprise at least two different types of light generating devices, more especially at least three different types of light generating devices. In yet further embodiments, the one or more light generating devices may comprise at least four different types, like at least five different types of light generating devices. Different types of light generating devices may herein, in embodiments, refer to light generating devices emitting light having different polarizations. However, especially in embodiments, different types of light generating devices may herein refer to light generating devices emitting light within different wavelength ranges. Especially, the different types of light generating devices may, in embodiments, be selected from the group comprising warm white, cool white, ultra-violet (UV), violet, blue, cyan, green, yellow, amber, orange, and red emitting light generating devices. Hence, in specific embodiments, the one or more light generating devices comprise at least four different types of light generating devices selected from the group of warm white, cool white, ultra-violet (UV), violet, blue, cyan, green, yellow, amber, orange, and red emitting light generating devices.

In embodiments, the light generating system may comprise different types of light generating devices. Especially, in embodiments, the different types of light generating devices may comprise different light sources.

The term “light source” may in principle relate to any light source known in the art. It may be a conventional (tungsten) light bulb, a low pressure mercury lamp, a high pressure mercury lamp, a fluorescent lamp, an LED (light emissive diode). In a specific embodiment, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The light source may have a light escape surface. Referring to conventional light sources such as light bulbs or fluorescent lamps, it may be an outer surface of a glass or a quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc . . . The term “light source” may also refer to an organic light-emitting diode (OLED), such as a passive-matrix (PMOLED) or an active-matrix (AMOLED). In a specific embodiment, the light source comprises a solid-state light source (such as an LED or laser diode). In an embodiment, the light source comprises an LED (light emitting diode). The terms “light source” or “solid state light source” may also refer to a superluminescent diode (SLED). The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as an LED, or downstream of a plurality of solid-state light sources (i.e. e.g. shared by multiple LEDs). In embodiments, the light source may comprise an LED with on-chip optics. In embodiments, the light source comprises pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation.

Secondary radiation may be based on conversion by a luminescent material. The secondary radiation may therefore also be indicated as luminescent material radiation. The luminescent material may in embodiments be comprised by the light source, such as an LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as an LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be used by the luminescent material. In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape,) and a spectral power distribution. The light source light may in embodiments comprise one or more bands, having band widths as known for lasers

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device). The term “light source” herein may also refer to a light source comprising a solid state light source, such as an LED or a laser diode or a superluminescent diode. The term “light source” may (thus) in embodiments also refer to a light source that is (also) based on conversion of light, such as a light source in combination with a luminescent converter material. Hence, the term “light source” may also refer to a combination of an LED with a luminescent material configured to convert at least part of the LED radiation, or to a combination of a (diode) laser with a luminescent material configured to convert at least part of the (diode) laser radiation. In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc. The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin. The term “solid state light source”, or “solid state material light source”, and similar terms, may especially refer to semiconductor light sources, such as a light emitting diode (LED), a diode laser, or a superluminescent diode.

Hence, the light generating devices may comprise different types of light sources. Further, in embodiments, the light generating devices may be configured to generate different types of device light. In embodiments, at least some of the light generating devices may be configured to generate white light.

The term “white light”, and similar terms, herein, are known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, the term “warm white light” may herein especially refer to light having a correlated color temperature (CCT) smaller than 3500 K, such as smaller than 3000 K, like smaller than 2500 K. Further, in embodiments, the term “cool white light” may herein refer to light having a correlated color temperature (CCT) equal to or larger than 3500 K, such as larger than 5000 K, like larger than 7000 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70.

In an embodiment, the light source may also provide light source light having a correlated color temperature (CCT) between about 5000 and 20000 K, e.g. direct phosphor converted LEDs (blue light emitting diode with thin layer of phosphor for e.g. obtaining of 10000 K). Hence, in a specific embodiment the light source is configured to provide light source light with a correlated color temperature in the range of 5000-20000 K, even more especially in the range of 6000-20000 K, such as 8000-20000 K. An advantage of the relative high color temperature may be that there may be a relatively high blue component in the light source light.

Further, in embodiments, at least some of the light generating devices may be configured to generate visible light, especially colored light.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm. The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to (at least) visible light. The terms “violet light” or “violet emission”, and similar terms, may especially relate to light having a wavelength in the range of about 380-440 nm. In specific embodiments, the violet light may have a centroid wavelength in the 380-440 nm range. The terms “blue light” or “blue emission”, and similar terms, may especially relate to light having a wavelength in the range of about 440-490 nm (including some violet and cyan hues). In specific embodiments, the blue light may have a centroid wavelength in the 440-490 nm range. The terms “green light” or “green emission”, and similar terms, may especially relate to light having a wavelength in the range of about 490-560 nm. In specific embodiments, the green light may have a centroid wavelength in the 490-560 nm range. The terms “yellow light” or “yellow emission”, and similar terms, may especially relate to light having a wavelength in the range of about 560-590 nm. In specific embodiments, the yellow light may have a centroid wavelength in the 560-590 nm range. The terms “orange light” or “orange emission”, and similar terms, may especially relate to light having a wavelength in the range of about 590-620 nm. In specific embodiments, the orange light may have a centroid wavelength in the 590-620 nm range. The terms “red light” or “red emission”, and similar terms, may especially relate to light having a wavelength in the range of about 620-750 nm. In specific embodiments, the red light may have a centroid wavelength in the 620-750 nm range. The terms “cyan light” or “cyan emission”, and similar terms, especially relate to light having a wavelength in the range of about 490-520 nm. In specific embodiments, the cyan light may have a centroid wavelength in the 490-520 nm range. The terms “amber light” or “amber emission”, and similar terms, may especially relate to light having a wavelength in the range of about 585-605 nm, such as about 590-600 nm. In specific embodiments, the amber light may have a centroid wavelength in the 585-605 nm range. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range.

Hence, in embodiments, the light generating system comprises at least three, like at least four, or in specific embodiments even at least five different types of light generating devices. The light generating system may also, in embodiments, comprise a center point (p). Especially, in embodiments, the (device) optical axis (O) may propagate through the center point (p). Especially, the term “optical axis” (O) may be defined as an imaginary line that defines the path along which light propagates through a system starting from the light generating element. More especially, the optical axis (O) may coincide with the direction of the light with the highest radiant flux. Hence, in embodiments, the different types of light generating devices may especially be configured around the center point (p), such that the highest radiant flux of the (total) device light may coincide with the optical axis (O). Further, in such embodiments, the light generating system may comprise of each of the different types (of light generating devices) a set of at least three light generating devices. Especially, the light generating devices of each set may have a shortest distance (DL), defined in a plane perpendicular to the optical axis (O), relative to the center point (p). Yet further, in embodiments, the light generating devices may especially be configured in a light generating device arrangement, such that the light generating devices within each set may be symmetrically distributed over the light generating device arrangement. Additionally or alternatively, the light generating devices may especially be configured in a light generating device arrangement, such that each light generating device may have at least two neighboring light generating devices of another type. Additionally or alternatively, the light generating devices may especially be configured in a light generating device arrangement, such that the light generating devices within one set may have at least two different shortest distances (DL). Hence, in specific embodiments, the light generating system may comprise a center point (p) and at least five different types of light generating devices, wherein the light generating system may comprise of each of the different types a set of at least three light generating devices, wherein the light generating devices of each set may have a shortest distance (DL) relative to the center point (p), wherein the light generating devices may be configured in a light generating device arrangement such that (i) light generating devices within each set are symmetrically distributed over the light generating device arrangement, (ii)each light generating device has at least two neighboring light generating devices of another type, and (iii) the light generating devices within one set have at least two different shortest distances (DL).

In embodiments, the at least five different types of light generating devices may especially comprise light generating devices generating different colors of light, as described above. In embodiments, the system light may comprise the different colors of device light from the different types of light generating devices. Hence, color mixing may be desired to create a uniform beam of system light. In embodiments, color mixing may be optimized through dedicated positioning of the different types of light generating devices (especially around the center point (p)). Especially, in embodiments, a symmetric distribution of the different types of light generating devices over the light generating device arrangement may provide improved color mixing as the resulting beam of system light may (also) be symmetric. Hence, in embodiments, the light generating device arrangement may have one of point symmetry, line symmetry, or rotational symmetry. Further, in embodiments, positioning a light generating device of a first type between two neighboring light generating devices of another type may provide improved color mixing as colors may be distributed balanced relative to each other. Especially, through such a distribution a high density input of one type of light generating device, which may be hard to soften through color mixing, may be avoided. Yet further, in embodiments, by positioning the light generating devices within each set at an equal shortest distance to the center point (p) the color mixing may be improved. In such embodiments, by placing the light generating devices within (only) one of the sets not at equal shortest distances to the center point (p) the beam width α may also (favorably) be reduced.

Hence, in embodiments, the different types of light generating devices may be arranged in the light generating device arrangement in a symmetrical and alternating fashion. For example, in embodiments, the light generating system may comprise a set of four light generating devices (e.g. configured to generate cool white light), a set of six light generating devices (e.g. configured to generate warm white light), and three (different) sets of four light generating devices (e.g. configured to generate visible light (especially four light generating devices each of red, green and blue light generating devices)). In such embodiments, the light generating devices may be configured such that two of the warm white light generating devices may be configured in the center, and the other 20 light generating devices may be configured surrounding the center two in a repeating, alternating pattern, e.g., cool white, warm white, red, green, blue, etc. Hence, the different types of light generating devices within each set may be symmetrically distributed and neighboring at least two light generating devices of another type.

In another example, in embodiments, the light generating system may comprise a set of two light generating devices (e.g. configured to generate cool white light), a set of four light generating devices (e.g. configured to generate warm white light), and three (different) sets of four light generating devices (e.g. configured to generate visible light (especially four light generating devices each of red, green and blue light generating devices)). In such embodiments, the light generating devices may be configured such that one of the cool white light generating devices together with one of the warm white light generating devices may be configured in the center, and the other 16 light generating devices may be configured surrounding the center two in a repeating, alternating pattern, e.g., cool white, warm white, red, green, blue, etc. It may be clear to the skilled person in the art that other light generating device arrangements may work as well, and are therefore herein not excluded.

Further, as mentioned above, the light generating devices may be configured around the center point (p). Hence, in embodiments, each light generating devices may have a shortest distance (DL) relative to the center point (p) defined in a plane perpendicular to the optical axis (O). Especially, in embodiments, the shortest distance (DL) may be selected from the range of 0.01-6 mm, such as from the range of 0.05-3 mm. In embodiments, the light generating devices within each set except one set may be positioned at an equal shortest distance (DL) relative to the center point (p). In such embodiments, the light generating devices within the one exceptional set may have at least two different shortest distances (DL) relative to the center point (p). Hence, in embodiments, for each of the sets of light generating devices, except one set, the light generating devices may be configured on an imaginary circle configured around the center point (p) with a radius equal to the shortest distance (DL) of the light generating devices of that respective set. For the one exceptional set, in such embodiments, the light generating devices may be configured on two or more imaginary circles configured around the center point (p) with a radius equal to two or more respective shortest distances (DL) of the light generating devices.

Yet further, for the arrangement of the light generating devices not only their individual orientation relative to each other may be relevant. Desirable may also be the features of the light generating device arrangement as a whole. Using different light generating devices and their arrangement may have an impact on the beam shape of the system light, the color mixing in the system light, and the creation of artefacts.

Especially, in embodiments the light generating device arrangement may be configured in an area having a maximum cross-sectional diameter (DE) defined perpendicular to the optical axis (O). In embodiments, the maximum cross-sectional diameter (DE) may be at most 150 mm, such as a most 100 mm, like at most 50 mm. Especially, in embodiments, the maximum cross-sectional diameter (DE) may be selected from the range of 1-150 mm, like from the range of 5-50 mm. Within the area defined by the cross-section diameter, all light generating devices of the light generating device arrangement are configured. Hence, especially the area is defined by the smallest circle enclosing all light generating devices of the light generating device arrangement.

In (other) embodiments, the light generating system may comprise a center point (p) and at least three different types of light generating devices. Especially, in such embodiments, the light generating system may comprise of each of the different types a set of at least two light generating devices. For example, in embodiments, the light generating system may comprise a set of two light generating devices of a first type, a set of four light generating devices of a second type, and a set of four light generating devices of a third type. More especially, in embodiments, the light generating devices of each set may have a shortest distance (DL). Furthermore, the light generating devices may be configured in a light generating device arrangement. In embodiments, the light generating devices within at least one set may be symmetrically distributed over the light generating device arrangement.

Optionally, in specific embodiments, the light generating devices within each set may be symmetrically distributed over the light generating device arrangement.

Further, in embodiments, the light generating devices may especially be configured in a light generating device arrangement, such that each light generating device may have at least two neighboring light generating devices of another type. Yet further, in embodiments, the light generating devices may especially be configured in a light generating device arrangement, such that the light generating devices within one set may have at least two different shortest distances (D_{L}).

For example, in embodiments, the light generating system may comprise a chip-on-board (CoB) light source. In such embodiments, the different types of light generating devices may comprise different light emitting diodes (LEDs) arranged on the CoB. The CoB may, in embodiments, have the maximum cross-sectional diameter (D_{E}) defined perpendicular to the optical axis (O). Especially, the CoB may have the maximum cross-sectional diameter (D_{E}) selected from the range of 15-100 mm.

The light generating system may especially be configured to generate system light. The system light may comprise device light emanating from the first lens array.

Optionally, further optics may be configured downstream of the first lens array. Especially, the system light may comprise beam shaped and homogenized device light, as provided via the first lens array (and other optics as described herein).

As there may be two or more light generating devices, of which at least two may be different types, the device light generated may be controlled. Effectively, hereby the system light may be controlled. Hence, in embodiments one or more optical properties of the system light may be controlled, like one or more of color point, and color rendering index, correlated color temperature. Hence, the light generating system may comprise a control system or may be functionally coupled to a control system. The control system may control the system light (by controlling the light generating devices, especially their radiant fluxes (over time)).

In a further aspect of the invention, the invention may provide an optical component. Especially, in embodiments, the optical component may comprise a collimator element and a first micro lens array (as defined above). In embodiments, the collimator element may comprise a first lens part and a second lens part. Especially, in embodiments, the second lens part may comprise a lower second lens part and an upper second lens part.

Further, in embodiments, the collimator element and the first micro lens array may be configured as an integrated body. Especially, in embodiments, the first micro lens array may be configured downstream of the collimator element. Embodiments described further above for the collimator element and the first micro lens array may also apply here for the optical component collimator element and optical component first micro lens array.

In a yet further aspect of the invention, the invention may provide an arrangement comprising the first micro lens array (as defined above) and the second micro lens array as described above. Especially, in embodiments, the first micro lens array may comprise a plurality of first micro lenses configured in a first tessellated arrangement.

Likewise, in embodiments, the second micro lens array may comprise a plurality of second micro lenses configured in a second tessellated arrangement. Especially, in embodiments, the first tessellated arrangement and the second tessellated arrangement may both comprise sunflower arrangements. More especially, in embodiments, the first tessellated arrangement and the second tessellated arrangement may comprise the same but mirrored sunflower arrangements.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc.. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc.. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

The light generating system as described above may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, automotive lighting systems or LCD backlighting. The light generating system (or luminaire) may be part of or may be applied in e.g. optical communication systems or disinfection systems.

In yet a further aspect, the invention also provides a lamp or a luminaire comprising the light generating system as defined herein. The luminaire may further comprise a housing, optical elements, louvres, etc. etc . . . The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also provides a lighting device selected from the group of a lamp, a luminaire, a projector device, a disinfection device, a photochemical reactor, an automotive lighting device, and an optical wireless communication device, comprising the light generating system as defined herein. The lighting device may comprise a housing or a carrier, configured to house or support, one or more elements of the light generating system. For instance, in embodiments the lighting device may comprise a housing or a carrier, configured to house or support one or more of the one or more light generating devices, and the optical system.

The term “centroid wavelength”, also indicated as Ac, is known in the art, and refers to the wavelength value where half of the light energy is at shorter and half the energy is at longer wavelengths; the value is stated in nanometers (nm). It is the wavelength that divides the integral of a spectral power distribution into two equal parts as expressed by the formula λc=Σ*I(λ)/(ΣI(λ)), where the summation is over the wavelength range of interest, and I(λ) is the spectral energy density (i.e. the integration of the product of the wavelength and the intensity over the emission band normalized to the integrated intensity). The centroid wavelength may e.g. be determined at operation conditions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1A-C and FIG. 3 schematically depict some embodiments of the invention.

FIGS. 2A-B and FIG. 4 schematically depicts some elements of the invention in further detail.

FIG. 5 schematically depicts some applications of the invention. The schematic drawings are not necessarily to scale.

### DETAILED DESCRIPTION OF THE EMBODIMENTS

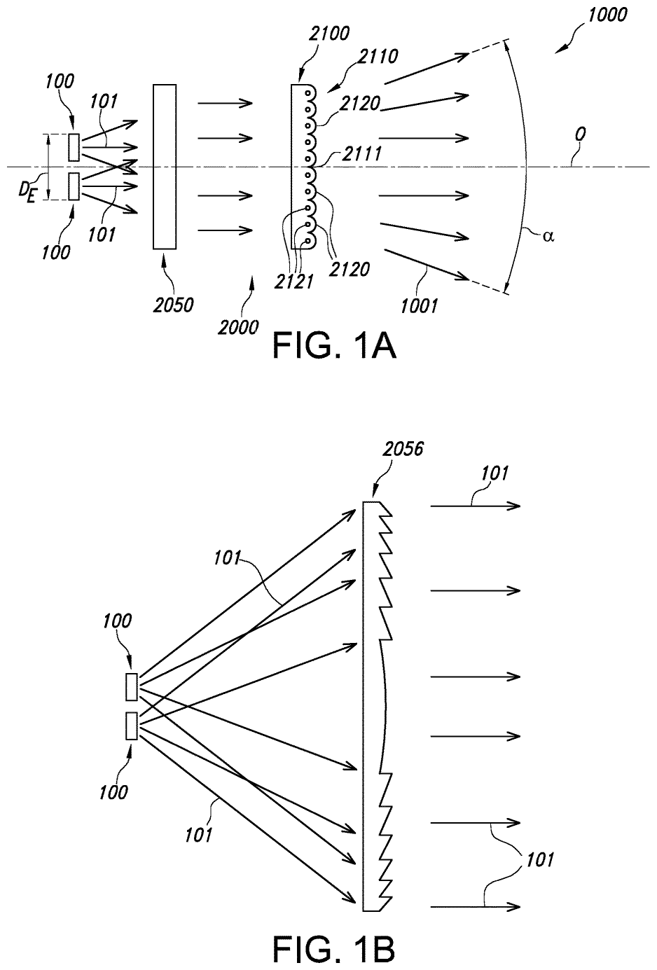

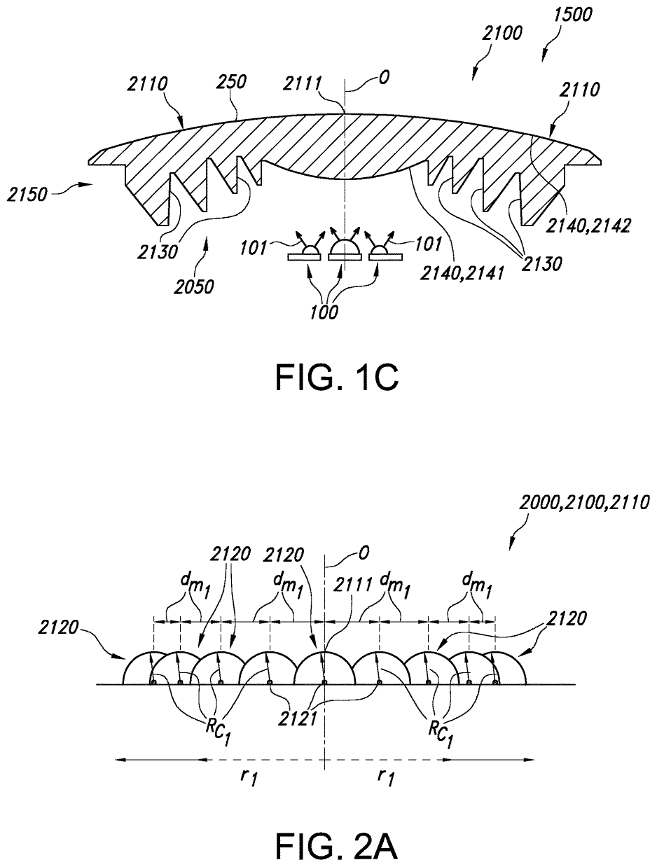

FIG. 1 schematically depicts some embodiments of the invention. Especially, the invention provides a light generating system 1000 comprising one or more light generating devices 100 and an optical system 2000. The light generating devices 100 may especially be configured to generate device light 101. In embodiments, the light generating devices 100 may be configured to generate visible device light 101, i.e., device light 101 having a wavelength in the visible wavelength range. The optical system 2000 may be configured in a light receiving relationship with the one or more light generating devices 100. Especially, in embodiments, the optical system 2000 may comprise an optical arrangement 2100 (configured in a light receiving relationship with the one or more light generating devices 100). In embodiments, the optical arrangement 2100 may comprise a first micro lens array 2110. Especially, the first micro lens array 2110 may comprise a plurality of first micro lenses 2120. More especially, the plurality of first micro lenses 2120 (in the first micro lens array 2110) may be configured in a first tessellated arrangement around a first central array point 2111. Hence, in embodiments, the first micro lens array 2110 may comprise an array of first micro lenses 2120 configured around the first central array point 2111. Hence, the first central array point 2111 may form the center of the first tessellated arrangement.

Reference O may especially refer to a (device) optical axis. In particular, the (device) optical axis O may be the optical axis of device light 101 propagating from the one or more light generating devices 100 (to the optical system 2000). In embodiments, the light generating system 1000 may be configured to provide system light 1001. Especially, in embodiments, the system light 1001, may comprise at least part of (such as essentially all of) the device light 101.

Reference a may especially refer to a beam width of a beam of system light 1001.

As depicted in FIG. 1a, in embodiments, the light generating system 1000 may comprise a collimator element 2050. Especially, the collimator element 2050 may be configured downstream of the one or more light generating devices 100 and upstream of the first micro lens array 2110. The collimator element 2050 may especially be configured in a light receiving relationship with the one or more light generating devices 100. Hence, the collimator element 2050 may be configured to collimate the device light 101 received by the collimator element 2050. In embodiments, the light generating devices 100 may be configured in a light generating device arrangement having a maximum cross-sectional diameter DE defined perpendicular to the optical axis O.

In specific embodiments, such as depicted in FIG. 1b, the collimator element 2050 may comprise a Fresnel-like lens element 2056. In such embodiments, the collimator element 2050 may be configured to collimate the device light 101 received by the collimator element 2050 through total internal reflection (TIR).

FIG. 1C schematically depicts an embodiment, wherein the optical arrangement 2000 may comprise (a) the collimator element 2050, and (b) the first micro lens array 2110. The collimator element 2140 may especially comprise a first lens part 2130 and a second lens part 2140. In embodiments, the second lens part 2140 may further comprise a lower second lens part 2141 and an upper second lens part 2142. The lower second lens part may, in embodiments, be configured downstream of the first lens part 2130. Further, the first micro lens array 2110 may especially be configured downstream of the upper second lens part 2142. In embodiments, the first lens part 2130 may be configured to collimate the device light 101 received by the first lens part 2130 through total internal reflection (TIR). Hence, in such embodiments, for example, the first lens part 2130 may comprise a Fresnel-like lens element 2056. Yet further, in embodiments, the second lens part 2140 may be configured to collimate device light 101 received by the second lens part 2140 through refraction. Yet further, in embodiments, the first micro lens array 2110 may be configured to beam shape and mix device light 101 received by the first micro lens array 2110.

Further, in embodiments, the light generating system 1000 may comprise a first optical arrangement body 2150. Especially, the first optical arrangement body 2150 may comprise the collimator element 2050, and the first micro lens array 2110 (as an integrated body). Further, in embodiments, the first optical arrangement body 2150 may have a light exit surface 250. The first micro lens array 2110 may, in embodiments, be configured on the light exit surface 250. In some embodiments, such as depicted here, the light exit surface 250 may be a curved light exit surface 250. Therefore, the first micro lens array 2110 may (also), in embodiments, be configured on the curved light exit surface 250.

In embodiments, the invention may (also) provide an optical component 1500. Especially, the optical component 1500 may comprise the collimator element 2050 and the first micro lens array 2110 as described herein and as depicted in FIG. 1C.

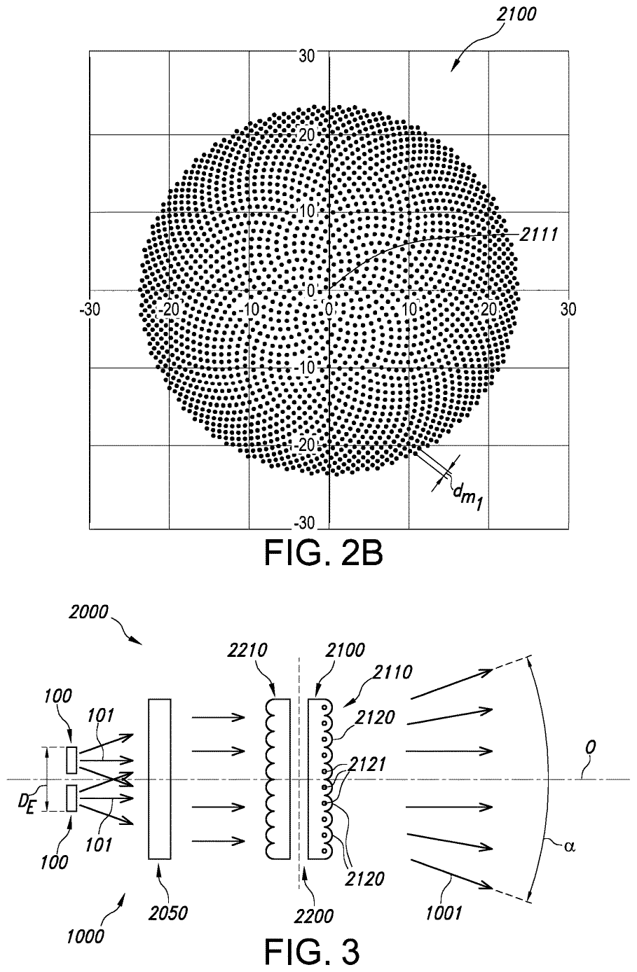

FIG. 2a schematically depicts the plurality of first micro lenses 2120 in more detail. Especially, the first micro lenses 2120 may have first radii of curvature R_{c1} and central first micro lens points 2121. In embodiments, with increasing radial distance r1 from the first central array point 2111, the first radii of curvature R_{c1} may stay constant. Especially, the first radii of curvature R_{c1} may stay constant with increasing radial distance r1 from the first central array point 2111, while mutual first heart-to-heart distances dₘ₁ between adjacent first micro lenses 2120 may decrease.

In embodiments, the first micro lens array 2110 may comprise at least 25 first micro lenses 2120, especially at least 100 first micro lenses 2120. Further, in embodiments, selected from the range of 0.0001-5%, especially 0.001-2% of the first micro lenses 2120 may have mutual first heart-to-heart distances (dₘ₁) selected from the range of 1.0-20 mm.

Yet in other embodiments, at least 90%, especially at least 95% of the first micro lenses 2120 may have mutual first heart-to-heart distances dₘ₁ selected from the range of smaller than 1.0 mm. Especially, in embodiments, dₘ₁≤0.95 mm, such as dₘ₁≤0.75 mm, like dₘ₁≤0.5 mm.

Further, FIG. 2b schematically depicts the first tessellated arrangement in more detail.

Especially, the first tessellated arrangement may comprise a sunflower arrangement. Such a sunflower arrangement may be represented in polar coordinates given by the equations: r1=c*SQRT[n] and θ=n*±(360°/(1.618034±q)), wherein r1 is the radial distance from the first central array point, c is a constant scaling factor, n is the index number of the micro lens, q is selected from 0, 1, 2, 3, . . . , 50, and θ is the step angle from n to n+1. In embodiments, q may (also) be a thousandths decimal point variation of 1, 2, 3, . . . , 50, e.g., 1.001, or 2.005. Each of the dots depicted in FIG. 2B may refer correspond to an index number n. Hence, in the present invention, each first micro lens 2110 may correspond to an index number n.

More especially, in embodiments, the first tessellated arrangement may comprise a progressive sunflower arrangement, such as depicted here. Such a progressive sunflower arrangement may be represented in polar coordinates given by the equations as described above for the sunflower arrangement, but wherein r1=c*x*SQRT[n] and θ=n*±(360°/(1.618034±q)). Hence, there is no longer constant scaling as x is a variable that may be changed (e.g. decreased) incrementally as the radial distance r1 increases. By decreasing x, the first micro lenses 2110 in the first tessellated arrangement become more densely populated with increasing r1, whereas by increasing x, the first micro lenses 2110 in the first tessellated arrangement become more spaciously populated with increasing r1. A first tessellated arrangement that is more densely populated with increasing r1 may be beneficial in embodiments where the first micro lens array 2110 receives a wide beam spread. In embodiments, for a relatively wide beam spread, the variable x may be at most 0.9, such as at most 1.0, like at most 1.1. Further, a first tessellated arrangement that is more spaciously populated with increasing r1 may be beneficial in embodiments where the first micro lens array 2110 receives a narrow beam spread, i.e., a more focused beam for example as a result of the collimator element 2050. In embodiments, for a relatively narrow beam spread, the variable x may be less than 1.0, such as less than 0.8, like less than 0.5.

Further, in embodiments, the first radii of curvature R_{c1} may have a number averaged average value R_{c1a}. Especially, the first radii of curvature R_{c1} for at least 95% of the first micro lenses 2120 may be selected from the range of 0.95*R_{c1a}-1.05*R_{c1a}. More especially, the mutual first heart-to-heart distances dₘ₁ may have (i) a first maximum value dₘₓ₁ closer to the first central array point 2111, and a first minimum value dₘₘ₁ at a periphery of the first micro lens array 2110. In embodiments, 0.1≤dₘₘ₁/dₘₓ₁≤0.9.

As depicted in FIG. 3, in other embodiments, the light generating system 1000 may (also) comprise a Koehler integrator element 2200. Especially, the Koehler integrator element 2200 may be configured downstream of the one or more light generating devices 100. In embodiments, the Koehler integrator element 2200 may comprise (a) a second micro lens array 2210 comprising a plurality of second micro lenses 2220 configured in a second tessellated arrangement, and (b) the first micro lens array 2110. Especially, in such embodiments, the first micro lenses 2120 and the second micro lenses 2220 may be aligned, i.e., their optical axes may coincide (as depicted here where they coincide on the (device) optical axis (O)). Furthermore, in embodiments, the first micro lenses 2120 may be configured downstream of the second micro lenses 2220.

Further, in embodiments where the light generating system 1000 comprises the Koehler integrator element 2200, the light generating system 1000 may (also) comprise the collimator element 2050 as defined above. Especially, in such embodiments, the Koehler integrator element 2200 may be configured downstream of the collimator element 2050.

Hence, the Koehler integrator element 2200 may be configured in a light receiving relationship with the collimator element 2050.

The first optical arrangement body 2150 and the second optical arrangement body 2250 may be individually manufactured according to one or more of a vacuum-casting process, an injection molding process, a printing process, or a direct milling process.

Further, in embodiments where the light generating system 1000 comprises the Koehler integrator element 2200, the first tessellated arrangement and the second tessellated arrangement may (also) comprise sunflower arrangements. More especially, in such embodiments, the first tessellated arrangement and the second tessellated arrangement may comprise progressive sunflower arrangements.

Especially, in embodiments, the first micro lens array 2110 and the second micro lens array 2210 may be mirror images of each other (relative to a plane configured in between). Hence, in embodiments, the first micro lens array 2110 and the second micro lens array 2210 may be essentially the same micro lens array, but mirrored (relative to a plane configured in between). Thus, the first tessellated arrangement and the second tessellated arrangement may comprise essentially the same progressive sunflower arrangements, but mirrored (relative to a plane configured in between).

As depicted in FIG. 4, in embodiments, the one or more light generating devices 100 may comprise at least three different types of light generating devices 100, such as at least four different types, like at least five different types of light generating devices 100. Different types of light generating devices 100 may herein refer to light generating devices 100 emitting light within different wavelength ranges. Especially, the different types of light generating devices 100 may, in embodiments, be selected from the group comprising warm white, cool white, ultra-violet (UV), violet, blue, cyan, green, yellow, amber, orange, and red emitting light generating devices 100.

Especially, in embodiments, the light generating system 1000 such as depicted in FIG. 4 comprises (at least) five different types of light generating devices 100. The five different types of light generating devices 100 may be configured around a center point p of the light generating system 1000. Further, in such embodiments, the light generating system comprises of each of the different types a set of at least three light generating devices 100, such as depicted in FIG. 4. The light generating devices 100 of each set may especially have a shortest distance DL relative to the center point p and defined in a plane perpendicular to the optical axis O.

Further, the light generating devices 100 may be configured in a light generating device arrangement 1100. In embodiments, the light generating device arrangement 1100 may have a maximum cross-sectional diameter DE defined perpendicular to the optical axis O. In embodiments, the light generating devices 100 may especially be configured in a light generating device arrangement 1100, such that the light generating devices 100 within each set are symmetrically distributed over the light generating device arrangement 1100. Additionally or alternatively, the light generating devices 100 may especially be configured in a light generating device arrangement 1100, such that each light generating device 100 may have at least two neighboring light generating devices 100 of another type. Additionally or alternatively, the light generating devices 100 may especially be configured in a light generating device arrangement 1100, such that the light generating devices 100 within one set may have at least two different shortest distances D_{L}.

As depicted here in FIG. 4, for example, the light generating system 1000 may comprise a set of four light generating devices 100 configured to generate cool white light, a set of six light generating devices 100 configured to generate warm white light, and three (different) sets of four light generating devices 100,110 configured to generate visible light (especially four light generating devices 100 each of red, green and blue light generating devices 100). In such embodiments, the light generating devices 100 may be configured such that two of the warm white light generating devices 100 may be configured in the center, i.e., nearest to the center point p, and the other 20 light generating devices 100 may be configured surrounding the center two in a repeating, alternating pattern, e.g., cool white, warm white, red, green, blue, etc. Further, as depicted here, for each of the sets of light generating devices 100, except one set, the light generating devices 100 may be configured on an imaginary circle configured around the center point p with a radius equal to the shortest distance DL of the light generating devices 100 of that respective set. For the one exceptional set, the light generating devices 110 may be configured on two (or more) imaginary circles configured around the center point p with a radius equal to two (or more) respective shortest distances DL of the light generating devices 110. Hence, in embodiments, the different types of light generating devices 100 within each set may be symmetrically distributed and neighboring at least two light generating devices 100 of another type in the light generating device arrangement 1100.

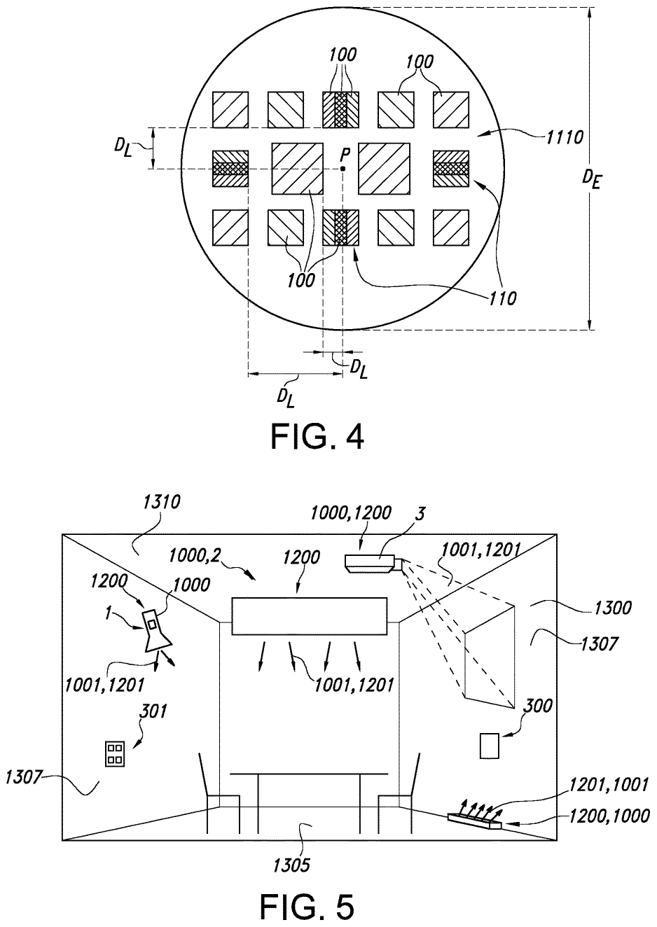

FIG. 5 schematically depicts an embodiment of a luminaire 2 comprising the light generating system 1000 as described above. Reference 301 indicates a user interface which may be functionally coupled with the control system 300 comprised by or functionally coupled to the light generating system 1000. FIG. 5 also schematically depicts an embodiment of lamp 1 comprising the light generating system 1000. Reference 3 indicates a projector device or projector system, which may be used to project images, such as at a wall, which may also comprise the light generating system 1000. Hence, FIG. 5 schematically depicts embodiments of a lighting device 1200 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, an automotive lighting device, or an optical wireless communication device. Lighting device light escaping from the lighting device 1200 is indicated with reference 1201. Lighting device light 1201 may essentially consist of system light 1001, and may in specific embodiments thus be system light 1001. Reference 1300 refers to a space, such as a room. Reference 1305 refers to a floor and reference 1310 to a ceiling; reference 1307 refers to a wall.

The term “plurality” refers to two or more. The terms “substantially” or “essentially” herein, and similar terms, will be understood by the person skilled in the art.

The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising (i) one or more light generating devices and (ii) an optical system; wherein:
the one or more light generating devices are configured to generate device light;
the optical system is configured in a light receiving relationship with the one or more light generating devices wherein the optical system comprises an optical arrangement;
the optical arrangement comprises a first micro lens array comprising a plurality of first micro lenses configured in a first tessellated arrangement around a first central array point, wherein the first micro lenses have first radii of curvature and central first micro lens points, wherein the first radii of curvature have a number averaged average value R_{c1a}, wherein with increasing radial distance from the first central array point mutual first heart-to-heart distances between adjacent first micro lenses decrease gradually, and wherein the first radii of curvature for at least 95% of the first micro lenses are selected from the range of 0.95*R_{c1a}-1.05*R_{c1a}.

2. The light generating system according to claim 1, wherein with increasing radial distance from the first central array point the first radii of curvature of the first micro lenses stay constant.

3. The light generating system according to claim 1, wherein the first tessellated arrangement comprises a sunflower arrangement; and wherein the mutual first heart-to-heart distances have a first maximum value closer to the first central array point, and a first minimum value at a periphery of the first micro lens array, wherein 0.1<dₘₘ₁/dₘₓ₁≤0.9.

4. The light generating system according to claim 1, further comprising a collimator element, configured downstream of the one or more light generating devices and upstream of the first micro lens array.

5. The light generating system according to claim 4, wherein the collimator element comprises a Fresnel-like lens element.

6. The light generating system according to claim 4, wherein:
the optical arrangement comprises (a) the collimator element, and (b) the first micro lens array;
the collimator element comprises (i) a first lens part, configured to collimate the device light received by the first lens part through total internal reflection, and (ii) a second lens part, configured to collimate the device light received by the second lens part through refraction; and
the first micro lens array is configured downstream of the first lens part and the second lens part and is configured to beam shape and mix device light received by the first micro lens array.

7. The light generating system according to claim 6, comprising a first optical arrangement body, wherein the first optical arrangement body comprises the collimator element, and the first micro lens array.

8. The light generating system according to claim 1, comprising a Koehler integrator element, configured downstream of the one or more light generating devices, wherein the Koehler integrator element comprises (a) a second micro lens array comprising a plurality of second micro lenses configured in a second tessellated arrangement, and (b) the first micro lens array, wherein the first micro lenses and the second micro lenses are aligned, and wherein the first micro lenses are configured downstream of the second micro lenses.

9. The light generating system according to claim 8, wherein the first tessellated arrangement and the second tessellated arrangement comprise sunflower arrangements, wherein the first micro lens array and the second micro lens array are mirror images of each other.

10. The light generating system according to claim 8, further comprising a collimator element, configured downstream of the one or more light generating devices and upstream of the first micro lens array, wherein the Koehler integrator element is configured downstream of the collimator element.

11. The light generating system according to claim 1, wherein the first micro lens array comprises at least 25 micro lenses; wherein selected from the range of 0.0001-5% of the first micro lenses have mutual first heart-to-heart distances selected from the range of 1.0-20 mm.

12. The light generating system according to claim 1, wherein the first micro lens array comprises at least 25 micro lenses, wherein at least 95% of the first micro lenses have mutual first heart-to-heart distances selected from the range of smaller than 1.0 mm.

13. The light generating system according to claim 1, wherein the light generating system comprises a center point and at least five different types of light generating devices, wherein the light generating system comprises of each of the different types a set of at least three light generating devices, wherein the light generating devices of each set have a shortest distance (relative to the center point, wherein the light generating devices are configured in a light generating device arrangement such that (i) light generating devices within each set are symmetrically distributed over the light generating device arrangement, (ii) each light generating device has at least two neighboring light generating devices of another type, and (iii) the light generating devices within one set have at least two different shortest distances.

14. An optical component comprising a collimator element, and a first micro lens array wherein the first micro lens array comprises a plurality of first micro lenses configured in a first tessellated arrangement around a first central array point, wherein the first micro lenses have first radii of curvature-and central first micro lens points, wherein the first radii of curvature have a number averaged average value R_{c1a}, wherein with increasing radial distance from the first central array point, mutual first heart-to-heart distances between adjacent first micro lenses decrease gradually, and wherein the first radii of curvature for at least 95% of the first micro lenses are selected from the range of 0.95*Rc1a-1.05*Rc1a,
wherein the collimator element comprises a first lens part and a second lens part, wherein the second lens part comprises a lower second lens part and an upper second lens part,
wherein the collimator element and the first micro lens array are configured as integrated body, and
wherein the first micro lens array is configured downstream of the collimator element.

15. A lighting device selected from the group of a lamp, a luminaire, a projector device, a disinfection device, a photochemical reactor, and an optical wireless communication device, comprising the light generating system according to claim 1.
